(19) United States
(12) Patent Application Publication
(10) Pub. No.: US 2007/0216605 A1
(43) Pub. Date: Sep. 20, 2007

(54) Method of driving plasma display apparatus

(76) Inventors: Byung Goo Kong, Seoul (KR); Tae Hyung Kim, Seoul (KR); Jong Woon Kwak, Anyang-si (KR)

Correspondence Address: KED & ASSOCIATES, LLP, P.O. Box 221200, Chantilly, VA, 20153-1200, US

(21) Appl. No.: 11/717,778

(22) Filed: Mar. 14, 2007

(30) Foreign Application Priority Data
Mar. 14, 2006 (KR) 10-2006-0023588

(51) Int. Cl. G09G 3/28

(52) U.S. Cl. 345/60

(57) ABSTRACT

A method of driving a plasma display apparatus is disclosed. In the method, a scan pulse is applied to a scan electrode during an address period, and a data pulse corresponding to the scan pulse is applied to an address electrode during the address period. The scan pulse falls from a scan reference voltage to a first intermediate voltage, is maintained at the first intermediate voltage, and falls from the first intermediate voltage to a scan voltage.

This application claims the benefit of Korean Patent Application No. 10-2006-0023588 filed on Mar. 14, 2006, which is hereby incorporated by reference.

### BACKGROUND

1. Field

This document relates to a display apparatus, and more particularly, to a method of driving a plasma display apparatus.

2. Description of the Related Art

Out of display apparatuses, a plasma display apparatus comprises a plasma display panel and a driver for driving the plasma display panel.

The plasma display panel has the structure in which barrier ribs formed between a front panel and a rear panel forms unit discharge cell or discharge cells. Each discharge cell is filled with an inert gas containing a main discharge gas such as neon (Ne), helium (He) or a mixture of Ne and He, and a small amount of xenon (Xe).

The plurality of discharge cells form one pixel. For example, a red (R) discharge cell, a green (G) discharge cell, and a blue (B) discharge cell form one pixel.

When the plasma display panel is discharged by a high frequency voltage, the inert gas generates vacuum ultraviolet rays, which thereby cause phosphors formed between the barrier ribs to emit light, thus displaying an image. Since the plasma display panel can be manufactured to be thin and light, it has attracted attention as a next generation display device.

### SUMMARY

In one aspect, a method of driving a plasma display apparatus comprises applying a scan pulse to a scan electrode during an address period, and applying a data pulse corresponding to the scan pulse to an address electrode during the address period, wherein the scan pulse falls from a scan reference voltage to a first intermediate voltage, is maintained at the first intermediate voltage, and falls from the first intermediate voltage to a scan voltage.

In another aspect, a method of driving a plasma display apparatus comprises applying a first scan pulse to a scan electrode during an address period, and applying a second scan pulse later than the first scan pulse to the scan electrode during the address period, wherein an absolute value of a first scan voltage of the first scan pulse is less than an absolute value of a second scan voltage of the second scan pulse.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention.

FIG. 1 illustrates a plasma display apparatus according to embodiments;

FIG. 2 illustrates one example of the structure of a plasma display panel of the plasma display apparatus according to the embodiments;

FIG. 3 is a timing diagram for illustrating a time-division driving method with one frame being divided into a plurality of subfields;

FIGS. 4a and 4b illustrate a driving waveform generated by a driving method of a plasma display apparatus according to a first embodiment;

FIGS. 5b and 5b illustrate a driving waveform generated by a driving method of a plasma display apparatus according to a second embodiment;

FIGS. 6a and 6b illustrate a driving waveform generated by a driving method of a plasma display apparatus according to a third embodiment; and

FIGS. 7a and 7b illustrate a driving waveform generated by a driving method of a plasma display apparatus according to a fourth embodiment.

### DETAILED DESCRIPTION OF PREFERRED EMBODIMENTS

Reference will now be made in detail embodiments of the invention examples of which are illustrated in the accompanying drawings.

A method of driving a plasma display apparatus comprises applying a scan pulse to a scan electrode during an address period, the scan pulse falling from a scan reference voltage to a first intermediate voltage, being maintained at the first intermediate voltage, and falling from the first intermediate voltage to a scan voltage, and applying a data pulse corresponding to the scan pulse to an address electrode during the address period.

The scan pulse may rise from the scan voltage to a second intermediate voltage, be maintained at the second intermediate voltage, and rise from the second intermediate voltage to the scan reference voltage.

A data voltage of the data pulse may be applied to the address electrode during the application of the scan voltage of the scan pulse to the scan electrode.

An absolute value of the first intermediate voltage may be substantially equal to an absolute value of the second intermediate voltage.

A sustain pulse alternately having a positive voltage and a negative voltage may be applied to the scan electrode and a ground level voltage may be applied to a sustain electrode during a sustain period which follows the address period.

A sustain pulse alternately having a positive voltage and a negative voltage may be applied to a sustain electrode and a ground level voltage may be applied to the scan electrode during a sustain period which follows the address period.

A method of driving a plasma display apparatus comprises applying a first scan pulse to a scan electrode during an address period, and applying a second scan pulse later than the first scan pulse to the scan electrode during the address period, wherein an absolute value of a first scan voltage of the first scan pulse is less than an absolute value of a second scan voltage of the second scan pulse.

A sustain pulse alternately having a positive voltage and a negative voltage may be applied to the scan electrode and a ground level voltage may be applied to a sustain electrode during a sustain period which follows the address period.

An absolute value of the negative voltage of the sustain pulse may be more than an absolute value of a scan reference voltage of the second scan pulse, and may be less than an absolute value of the second scan voltage of the second scan pulse.

A sustain pulse alternately having a positive voltage and a negative voltage may be applied to a sustain electrode and a ground level voltage may be applied to the scan electrode during a sustain period which follows the address period.

An absolute value of the negative voltage of the sustain pulse may be more than an absolute value of a scan reference voltage of the second scan pulse, and may be less than an absolute value of the second scan voltage of the second scan pulse.

The second scan pulse may fall from a scan reference voltage to a first intermediate voltage, be maintained at the first intermediate voltage, and fall from the first intermediate voltage to the second scan voltage.

The second scan pulse may rise from the second scan voltage to a second intermediate voltage, be maintained at the second intermediate voltage, and rise from the second intermediate voltage to the scan reference voltage.

A data voltage of a data pulse corresponding to the second scan pulse may be applied to the address electrode during the application of the second scan voltage of the second scan pulse to the scan electrode.

An absolute value of the first intermediate voltage may be substantially equal to an absolute value of the second intermediate voltage.

The first scan pulse may fall from the scan reference voltage to a third intermediate voltage, be maintained at the third intermediate voltage, and fall from the third intermediate voltage to the first scan voltage.

The first scan pulse may rise from the first scan voltage to a fourth intermediate voltage, be maintained at the fourth intermediate voltage, and rise from the fourth intermediate voltage to the scan reference voltage.

A data voltage of a data pulse corresponding to the first scan pulse may be applied to the address electrode during the application of the first scan voltage of the first scan pulse to the scan electrode.

An absolute value of the third intermediate voltage may be substantially equal to an absolute value of the fourth intermediate voltage.

Hereinafter, exemplary embodiments of the present invention will be described in detail with reference to the attached drawings.

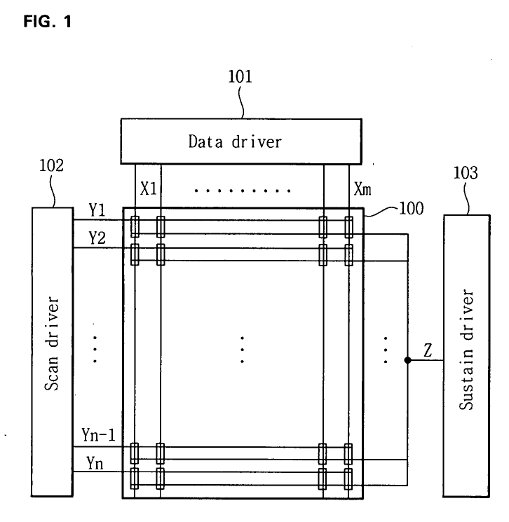

FIG. 1 illustrates a plasma display apparatus according to embodiments.

Referring to FIG. 1, the plasma display apparatus according to the embodiments includes a plasma display panel 100 and a driver for applying a predetermined driving voltage to electrodes of the plasma display panel 100. The driver includes a data driver 101, a scan driver 102, and a sustain driver 103.

The scan driver 102 and the sustain driver 103 may correspond to a first driver. The data driver 101 may correspond to a second driver.

The plasma display panel 100 includes a front panel (not illustrated) and a rear panel (not illustrated) which are coalesced at a given distance therebetween, and a plurality of electrodes. The plurality of electrodes include scan electrode Y1 to Yn, sustain electrodes Y, and address electrodes X1 to Xn.

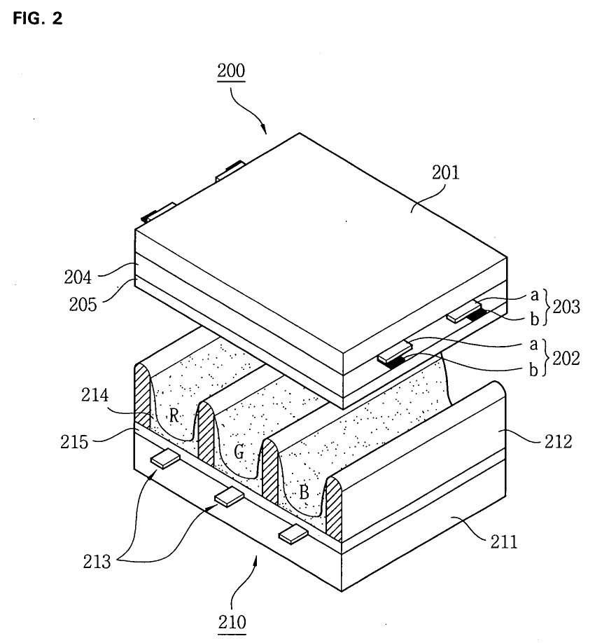

The following is a detailed description of the structure of the plasma display panel 100 with reference to FIG. 2.

As illustrated in FIG. 2, the plasma display panel 100 of the plasma display apparatus according to the embodiments includes a front panel 200 and a rear panel 210 which are coupled in parallel opposite to each other at a given distance therebetween. The front panel 200 includes a front substrate 201 being a display surface on which an image is displayed. The rear panel 210 includes a rear substrate 211 constituting a rear surface. A plurality of scan electrodes 202 and a plurality of sustain electrodes 203 are formed on the front substrate 201. A plurality of address electrodes 213 are arranged on the rear substrate 211 to intersect the scan electrodes 202 and the sustain electrodes 203.

The scan electrode 202 and the sustain electrode 203 each include transparent electrodes 202a and 203a made of transparent indium-tin-oxide (ITO) material, and bus electrodes 202b and 203b made of a metal material. The scan electrode 202 and the sustain electrode 203 generate a mutual discharge therebetween in one discharge cell, and maintain light-emissions of the discharge cells.

The scan electrode 202 and the sustain electrode 203 are covered with one or more upper dielectric layers 204 for limiting a discharge current and providing insulation between the scan electrode 202 and the sustain electrode 203. A protective layer 205 with a deposit of MgO is formed on an upper surface of the upper dielectric layer 204 to facilitate discharge conditions.

A plurality of stripe-type (or well-type) barrier ribs 212 are arranged in parallel on the rear substrate 211 of the rear panel 210 to form a plurality of discharge spaces (i.e., a plurality of discharge cells). The plurality of address electrodes 213 for performing an address discharge to generate vacuum ultraviolet rays are arranged in parallel to the barrier ribs 212.

An upper surface of the rear panel 210 is coated with Red (R), green (G) and blue (B) phosphors 214 for emitting visible light for an image display during the generation of the address discharge is performed. A lower dielectric layer 215 is formed between the address electrodes 213 and the phosphors 214 to protect the address electrodes 213.

Although FIG. 2 has illustrated and described only one example of the plasma display panel applicable to the embodiments, the embodiments are not limited to the structure of the plasma display panel illustrated in FIG. 2.

For example, FIG. 2 has illustrated the scan electrode 202 and the sustain electrode 203 each including the transparent electrode and the bus electrode. However, at least one of the scan electrode 202 and the sustain electrode 203 may include either the bus electrode or the transparent electrode.

Further, FIG. 2 has illustrated and described the structure of the plasma display panel, in which the front panel 200 includes the scan electrode 202 and the sustain electrode 203 and the rear panel 210 includes the address electrode 213. However, the front panel 200 may include all of the scan electrode 202, the sustain electrode 203, and the address electrode 213. At least one of the scan electrode 202, the sustain electrode 203, and the address electrode 213 may be formed on the barrier rib 212.

Considering the structure of the plasma display panel of FIG. 2, the plasma display panel applicable to the embodiments has only to include the scan electrode 202, the sustain electrode 203, and the address electrode 210. The plasma display panel may have various structures as long as the above-described structural characteristics are satisfied.

The description of FIG. 2 is completed, and the description of FIG. 1 continues again.

The scan driver 102 supplies a setup pulse and set-down pulse during a reset period, a scan pulse during an address period, and a sustain pulse having a positive voltage and a negative voltage or a ground level voltage during a sustain period to the scan electrode Y of the plasma display panel 100.

The sustain driver 103 supplies a sustain pulse having a positive voltage and a negative voltage or a ground level voltage to the sustain electrode Z during the sustain period.

The data driver 101 supplies a data pulse to the address electrode X during the address period.

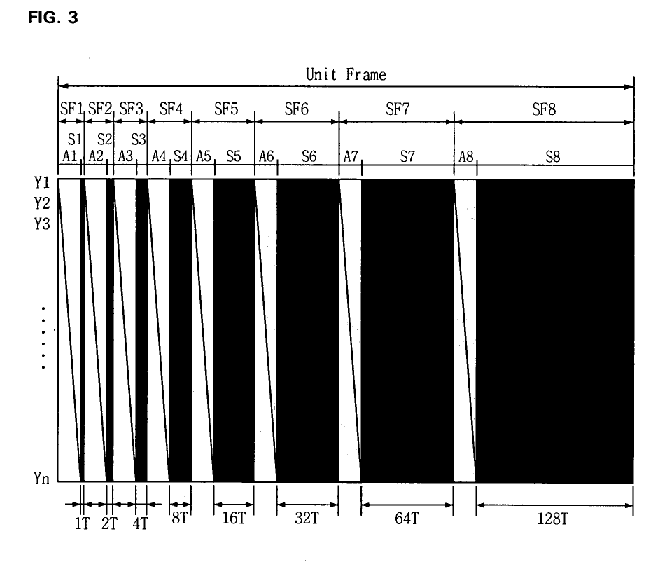

FIG. 3 is a timing diagram for illustrating a time-division driving method with one frame being divided into a plurality of subfields.

As illustrated in FIG. 3, a unit frame may be divided into a predetermined number of subfields, for example, 8 subfields SF1 to SF8 to represent time-division gray scale. Each of the 8 subfields SF1 to SF8 is divided into a reset period (not illustrated), an address period A, and a sustain period S.

During each of the address periods A1 to A8, data pulses are applied to the address electrodes, and scan pulses corresponding to the data pulses are sequentially applied to the scan electrodes Y1 to Yn.

During each of the sustain periods S1 to S8, sustain pulses are applied to the scan electrodes Y1 to Yn or the sustain electrodes. This results in the generation of a sustain discharge inside the discharge cells in which wall charges generated during the address periods A1 to A8 are accumulated.

A luminance of the plasma display panel is proportional to the number of sustain pulses generated during the sustain periods S1 to S8 of the unit frame. For example, if one image with 256 gray levels is to be displayed in the 8 subfields SF1 to SF8, the sustain period increases in a ratio of 2ⁿ (where, n=0, 1, 2, 3, 4, 5, 6, 7) in each subfield. In other words, the sustain period may vary from one subfield to the next subfield.

If a luminance of 133 gray levels is to be represented, the luminance of 133 gray levels is represented by the generation of sustain discharges through the addressing of the discharge cells during the subfields SF1, SF3, and SF8.

The number of sustain discharges assigned to each of the subfields SF1 to SF8 may vary depending on weights of the subfields in accordance with Automatic Power Control (APC).

The number of sustain discharges assigned to each of the subfields SF1 to SF8 may vary in consideration of gamma or panel characteristics. For example, a gray level assigned to the subfield SF4 may fall from 8 to 6, and a gray level assigned to the subfield SF6 may rise from 32 to 34. Further, the number of subfields constituting one frame may vary according to design specifications.

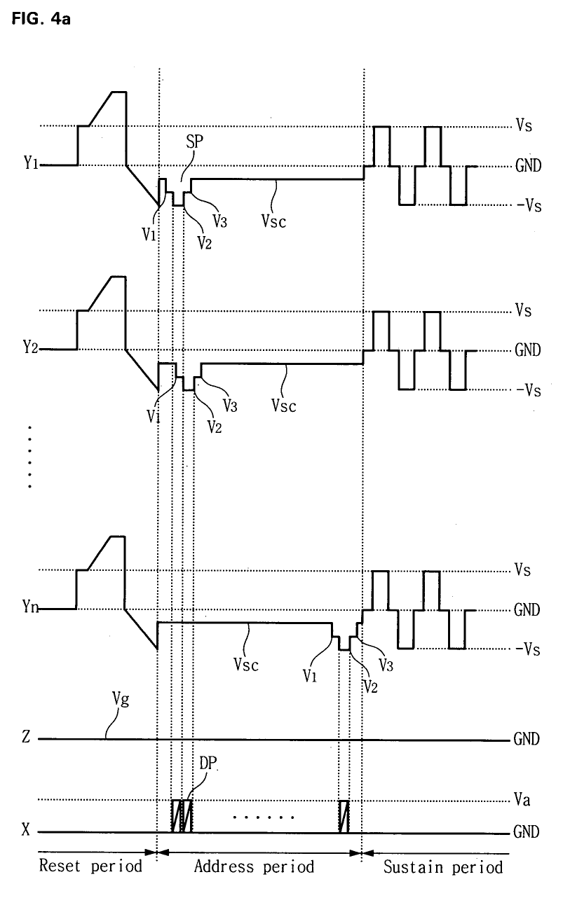

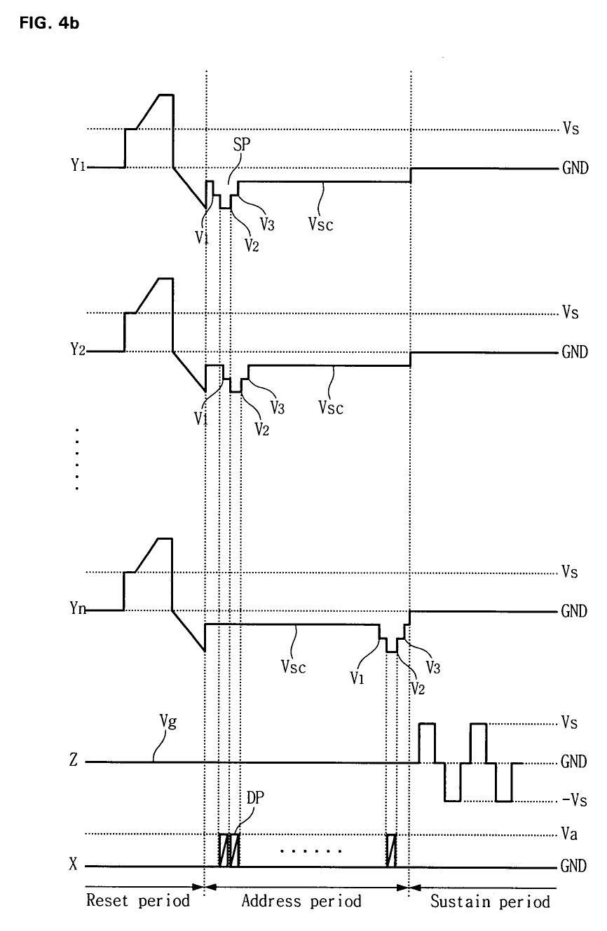

FIGS. 4a and 4b illustrate a driving waveform generated by a driving method of a plasma display apparatus according to a first embodiment.

As illustrated in FIG. 4a, one subfield is divided into a reset period, an address period, and a sustain period.

During a reset period, a ground level voltage GND is first applied to the scan electrodes Y1 to Yn, and a sustain voltage Vs is sharply applied to the scan electrodes Y1 to Yn. Then, a rising pulse with a gradually rising voltage is applied to the scan electrodes Y1 to Yn. Voltages of the scan electrodes Y1 to Yn reach the highest rising voltage.

The application of the rising pulse generates a weak discharge such that negative charges are accumulated around the scan electrodes Y1 to Yn. A falling pulse sharply falling to the ground level voltage GND is applied to the scan electrodes Y1 to Yn. The voltages of the scan electrodes Y1 to Yn reach the lowest falling voltage.

The application of the falling pulse generates a discharge such that a portion of the negative charges accumulated around the scan electrodes Y1 to Yn is erased. Accordingly, the remaining negative charges around the scan electrodes are uniform to the extent that an address discharge occurs stably. The ground level voltage GND is applied to the sustain electrodes Z and the address electrodes X.

The ground level voltage GND is applied to the sustain electrodes Z all over the address period and the sustain period as well as the reset period. Therefore, a circuit for applying a pulse to the sustain electrodes Z is removed such that the manufacturing cost of a driving circuit is reduced.

During the address period, a scan reference voltage Vsc is applied to the scan electrodes Y1 to Yn, and then scan pulses SP having a negative scan voltage V2 are sequentially applied to the scan electrodes Y1 to Yn, thereby selecting the discharges cells to be turned on.

Data pulses DP having a data voltage Va are applied to the address electrodes X to correspond to the scan pulses SP. The ground level voltage GND is constantly applied to the sustain electrodes Z.

The scan pulse SP falls from the scan reference voltage Vsc to a first intermediate voltage V1, is maintained at the first intermediate voltage V1, and falls from the first intermediate voltage V1 to a scan voltage V2.

The discharges cells to be turned on are selected by maintaining the scan pulse SP at the scan voltage V2 while the data pulse DP has the data voltage Va.

Then, the scan pulse SP rises from the scan voltage V2 to a second intermediate voltage V3, is maintained at the second intermediate voltage V3, and rises from the second intermediate voltage V3 to the scan reference voltage Vsc.

In the related art, a predetermined bias voltage was applied to the sustain electrode during the application of a scan pulse to the scan electrode such that the generation of an erroneous discharge between the scan electrode and the sustain electrode was prevented by reducing a voltage difference between the scan electrode and the sustain electrode.

However, in the first embodiment, the ground level voltage GND is applied to the sustain electrode Z during the address period such that an erroneous discharge may occur due to a voltage difference between the scan electrode Y and the sustain electrode Z.

Accordingly, in the first embodiment, the scan pulse SP falls to the scan voltage V2 through the first and second intermediate voltages V1 and V3 such that the generation of an erroneous discharge between the scan electrode Y and the sustain electrode Z is prevented by reducing the voltage difference between the scan electrode Y and the sustain electrode Z.

An absolute value of the first intermediate voltage V1 may be substantially equal to an absolute value of the second intermediate voltage V3.

The address discharge is performed by the data voltage Va, the scan voltage V2, a wall voltage caused by negative charges accumulated around the scan electrodes, and a wall voltage caused by positive charges accumulated around the address electrodes.

After performing the address discharge, positive charges are accumulated around the scan electrodes Y, and negative charges are accumulated around the sustain electrodes Z.

During the sustain period, sustain pulses alternately having a positive sustain voltage Vs and a negative sustain voltage −Vs are applied to the scan electrodes Y1 to Yn. The ground level voltage GND is applied to the sustain electrodes Z.

As illustrated in FIG. 4a, during the sustain period, an intermediate voltage (i.e., the ground level voltage GND) between the positive sustain voltage Vs and the negative sustain voltage −Vs may be applied to the scan electrodes Y1 to Yn.

The application of the ground level voltage GND prevents a sharp change in voltages between the positive sustain voltage Vs and the negative sustain voltage −Vs.

When the positive sustain voltage Vs is applied to the scan electrode Y, a sustain discharge is performed by the positive sustain voltage Vs applied to the scan electrode Y, the ground level voltage GND applied to the sustain electrode Z, a wall voltage caused by positive charges accumulated around the scan electrode Y, and a wall voltage caused by negative charges accumulated around the sustain electrode Z. After performing the sustain discharge, negative charges are accumulated around the scan electrode Y, and positive charges are accumulated around the sustain electrodes Z.

When the negative sustain voltage −Vs is applied to the scan electrode Y, a sustain discharge is performed by the negative sustain voltage −Vs applied to the scan electrode Y, the ground level voltage GND applied to the sustain electrode Z, a wall voltage caused by negative charges accumulated around the scan electrode Y, and a wall voltage caused by positive charges accumulated around the sustain electrode Z. After performing the sustain discharge, positive charges are accumulated around the scan electrode Y, and negative charges are accumulated around the sustain electrodes Z.

As above, as the positive sustain voltage Vs and the negative sustain voltage −Vs are alternately applied repeatedly to the scan electrodes Y, a set number of sustain discharges occurs.

FIG. 4a has illustrated and described the case where the sustain pulses alternately having the positive sustain voltage Vs and the negative sustain voltage −Vs are applied to the scan electrodes Y1 to Yn and the ground level voltage GND is applied to the sustain electrodes Z during the sustain period. However, the first embodiment is not limited thereto.

As illustrated in FIG. 4b, during the sustain period, the sustain pulses alternately having the positive sustain voltage Vs and the negative sustain voltage −Vs may be applied to the sustain electrodes Z and the ground level voltage GND may be applied to the scan electrodes Y1 to Yn.

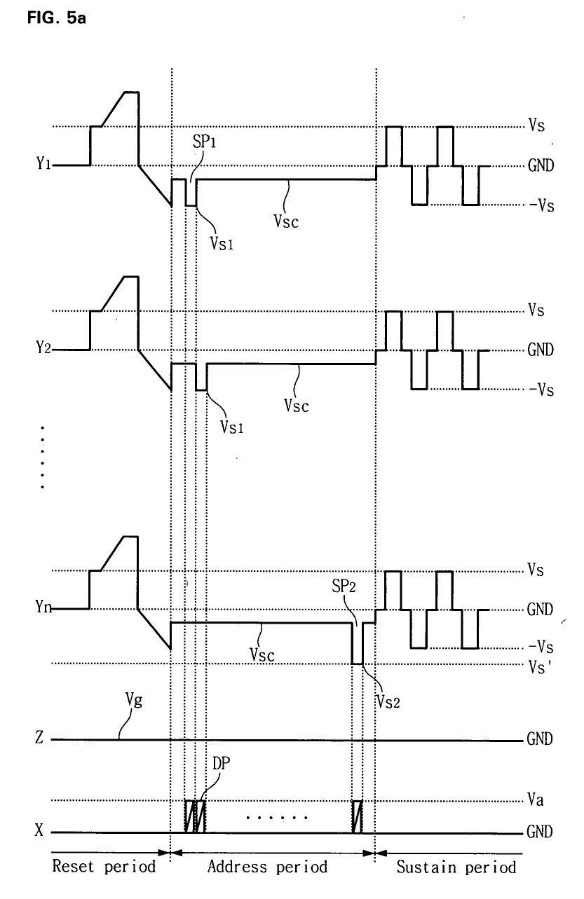

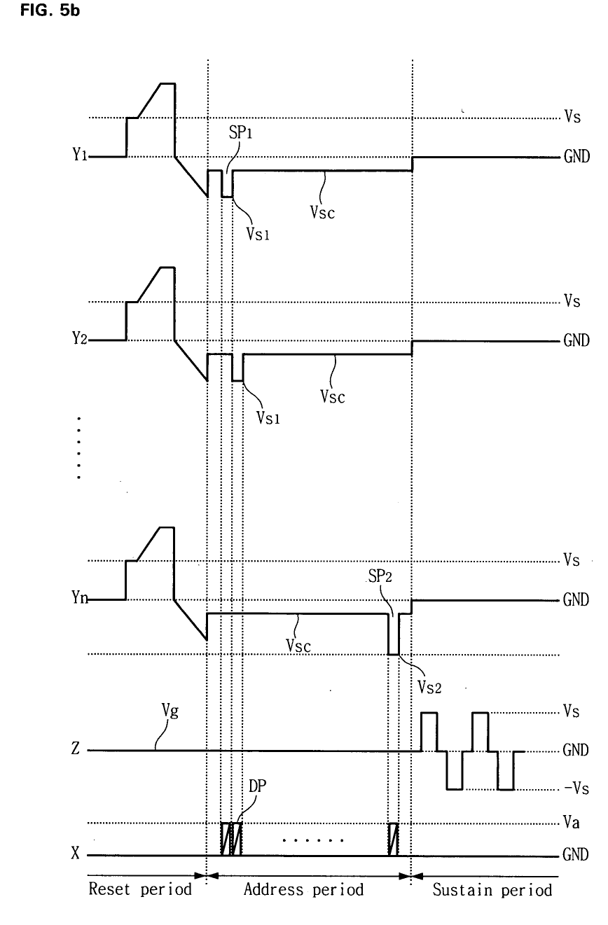

FIGS. 5b and 5b illustrate a driving waveform generated by a driving method of a plasma display apparatus according to a second embodiment.

Characteristics of the driving waveform described in the second embodiment identical or equivalent to the characteristics of the driving waveform described in the first embodiment is briefly made or is entirely omitted.

As illustrated in FIG. 5b, when scan pulses are sequentially applied to the scan electrodes Y1 to Yn during an address period, voltage magnitudes of the scan pulses applied to the scan electrodes Y1 to Yn increase as the address period elapses.

For example, when a first scan pulse SP1 is applied to the scan electrode Y1 and a second scan pulse SP2 is applied to the scan electrode Yn, the second scan pulse SP2 is applied later than the first scan pulse SP1.

In this case, when an absolute value of a first scan voltage Vs1 of the first scan pulse SP1 is equal to an absolute value of a second scan voltage Vs2 of the second scan pulse SP2, wall charges accumulated on the scan electrodes and the address electrodes during a reset period are erased as the address period elapses. In particular, as kinetic energy of the wall charges increases at a high temperature, the wall charges are much erased such that there may be little discharge between the scan electrode and the address electrode due to a reduction in a voltage difference (i.e., an external application voltage) between the scan pulse and the data pulse.

However, in the second embodiment, the absolute value of the second scan voltage Vs2 of the second scan pulse SP2 is more than the absolute value of the first scan voltage Vs1 of the first scan pulse SP1 (i.e., the voltage magnitudes of the scan pulses applied to the scan electrodes Y1 to Yn increase as the address period elapses). Accordingly, although wall charges accumulated on the scan electrodes and the address electrodes during the reset period are erased and a wall voltage between the scan electrodes and the address electrodes is reduced, the voltage difference (i.e., the external application voltage) between the scan pulse and the data pulse increases such that an address discharge easily occurs between the scan electrodes and the address electrodes.

FIG. 5b has illustrated and described the case where the sustain pulses alternately having the positive sustain voltage Vs and the negative sustain voltage −Vs are applied to the scan electrodes Y1 to Yn and the ground level voltage GND is applied to the sustain electrodes Z during the sustain period. However, the second embodiment is not limited thereto.

As illustrated in FIG. 5b, during the sustain period, the sustain pulses alternately having the positive sustain voltage Vs and the negative sustain voltage −Vs may be applied to the sustain electrodes Z and the ground level voltage GND may be applied to the scan electrodes Y1 to Yn.

An absolute value of the negative sustain voltage −Vs of the sustain pulse applied to the scan electrode Y or the sustain electrode may be more than an absolute value of the scan reference voltage Vsc applied to the scan electrode Y during the address period, and less than an absolute value of the second scan voltage Vs2 of the second scan pulse SP2.

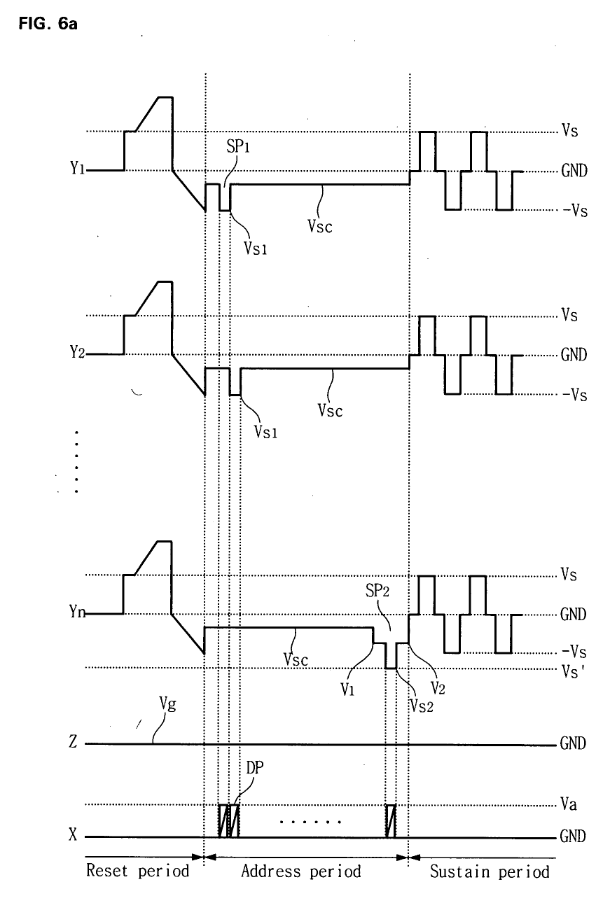

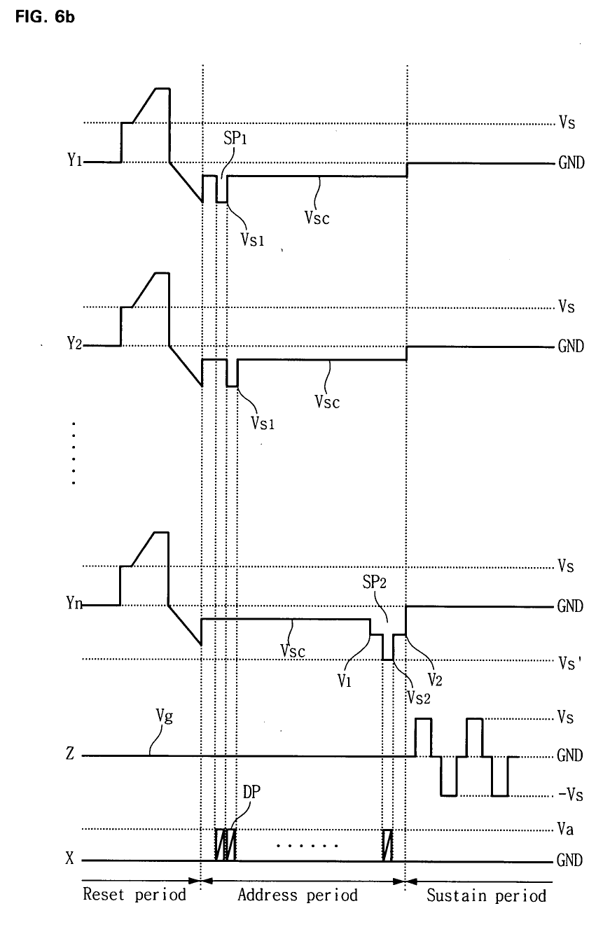

FIGS. 6a and 6b illustrate a driving waveform generated by a driving method of a plasma display apparatus according to a third embodiment.

Characteristics of the driving waveform described in the third embodiment identical or equivalent to the characteristics of the driving waveform described in the second embodiment is briefly made or is entirely omitted.

As illustrated in FIG. 6a, when a second scan pulse SP2 is applied later than a first scan pulse SP1 during an address period, the second scan pulse SP2 falls from a scan reference voltage Vsc to a first intermediate voltage V1, is maintained at the first intermediate voltage V1, and falls from the first intermediate voltage V1 to a second scan voltage Vs2.

The discharges cells to be turned on are selected by maintaining the second scan pulse SP2 at the second scan voltage V2 while a data pulse DP corresponding to the second scan pulse SP2 has a data voltage Va.

Then, the second scan pulse SP2 rises from the second scan voltage Vs2 to a second intermediate voltage V2, is maintained at the second intermediate voltage V2, and rises from the second intermediate voltage V2 to the scan reference voltage Vsc.

In the related art, a predetermined bias voltage was applied to the sustain electrode during the application of a scan pulse to the scan electrode such that the generation of an erroneous discharge between the scan electrode and the sustain electrode was prevented by reducing a voltage difference between the scan electrode and the sustain electrode.

However, in the third embodiment, the ground level voltage GND is applied to the sustain electrode Z during the address period such that an erroneous discharge may occur due to a voltage difference between the scan electrode Y and the sustain electrode Z.

Accordingly, in the third embodiment, the second scan pulse SP2 falls to the second scan voltage Vs2 through the first and second intermediate voltages V1 and V2 such that the generation of an erroneous discharge between the scan electrode Y and the sustain electrode Z is prevented by reducing the voltage difference between the scan electrode Y and the sustain electrode Z.

An absolute value of the first intermediate voltage V1 may be substantially equal to an absolute value of the second intermediate voltage V2.

FIG. 6a has illustrated and described the case where the sustain pulses alternately having the positive sustain voltage Vs and the negative sustain voltage −Vs are applied to the scan electrodes Y1 to Yn and the ground level voltage GND is applied to the sustain electrodes Z during the sustain period. However, the third embodiment is not limited thereto.

As illustrated in FIG. 6b, during the sustain period, the sustain pulses alternately having the positive sustain voltage Vs and the negative sustain voltage −Vs may be applied to the sustain electrodes Z and the ground level voltage GND may be applied to the scan electrodes Y1 to Yn.

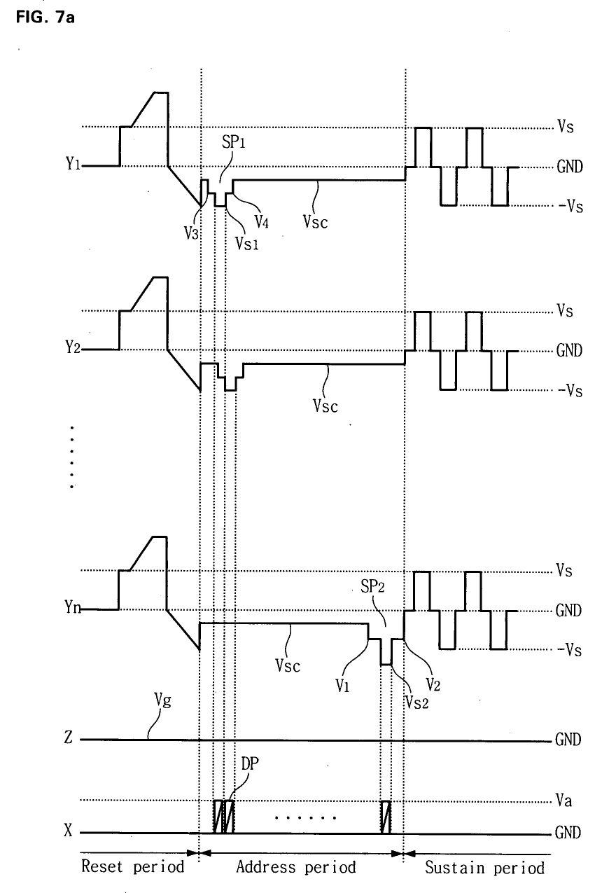

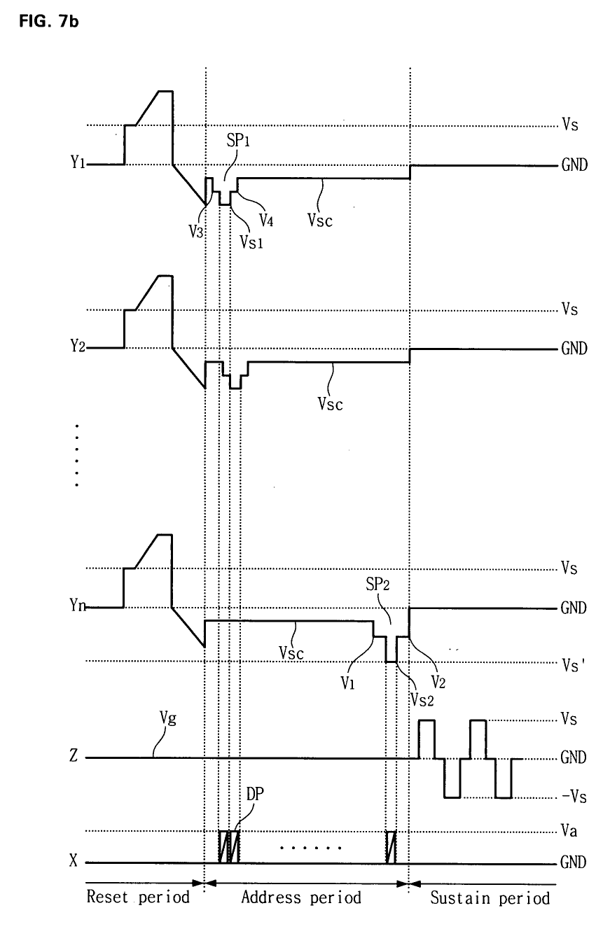

FIGS. 7a and 7b illustrate a driving waveform generated by a driving method of a plasma display apparatus according to a fourth embodiment.

Characteristics of the driving waveform described in the fourth embodiment identical or equivalent to the characteristics of the driving waveform described in the third embodiment is briefly made or is entirely omitted.

As illustrated in FIG. 7a, when a second scan pulse SP2 is applied later than a first scan pulse SP1 during an address period, the second scan pulse SP2 falls from a scan reference voltage Vsc to a first intermediate voltage V1, is maintained at the first intermediate voltage V1, and falls from the first intermediate voltage V1 to a second scan voltage Vs2.

The discharges cells to be turned on are selected by maintaining the second scan pulse SP2 at the second scan voltage Vs2 while a data pulse DP corresponding to the second scan pulse SP2 has a data voltage Va.

Then, the second scan pulse SP2 rises from the second scan voltage Vs2 to a second intermediate voltage V2, is maintained at the second intermediate voltage V2, and rises from the second intermediate voltage V2 to the scan reference voltage Vsc.

Similar to the second scan pulse SP2, the first scan pulse SP1 falls from the scan reference voltage Vsc to a third intermediate voltage V3, is maintained at the third intermediate voltage V3, and falls from the third intermediate voltage V3 to a first scan voltage Vs1.

The discharges cells to be turned on are selected by maintaining the first scan pulse SP1 at the first scan voltage Vs1 while the data pulse DP corresponding to the first scan pulse SP1 has the data voltage Va.

Then, the first scan pulse SP1 rises from the first scan voltage Vs1 to a fourth intermediate voltage V4, is maintained at the fourth intermediate voltage V4, and rises from the fourth intermediate voltage V4 to the scan reference voltage Vsc.

In the related art, a predetermined bias voltage was applied to the sustain electrode during the application of a scan pulse to the scan electrode such that the generation of an erroneous discharge between the scan electrode and the sustain electrode was prevented by reducing a voltage difference between the scan electrode and the sustain electrode.

However, in the fourth embodiment, the ground level voltage GND is applied to the sustain electrode Z during the address period such that an erroneous discharge may occur due to a voltage difference between the scan electrode Y and the sustain electrode Z.

Accordingly, in the fourth embodiment, the first scan pulse SP1 falls to the first scan voltage Vs1 through the third and fourth intermediate voltages V3 and V4 and the second scan pulse SP2 falls to the second scan voltage Vs2 through the first and second intermediate voltages V1 and V2 such that the generation of an erroneous discharge between the scan electrode Y and the sustain electrode Z is prevented by reducing the voltage difference between the scan electrode Y and the sustain electrode Z.

An absolute value of the first intermediate voltage V1 may be substantially equal to an absolute value of the second intermediate voltage V2. Further, An absolute value of the third intermediate voltage V3 may be substantially equal to an absolute value of the fourth intermediate voltage V4.

FIG. 7a has illustrated and described the case where the sustain pulses alternately having the positive sustain voltage Vs and the negative sustain voltage −Vs are applied to the scan electrodes Y1 to Yn and the ground level voltage GND is applied to the sustain electrodes Z during the sustain period. However, the fourth embodiment is not limited thereto.

As illustrated in FIG. 7b, during the sustain period, the sustain pulses alternately having the positive sustain voltage Vs and the negative sustain voltage −Vs may be applied to the sustain electrodes Z and the ground level voltage GND may be applied to the scan electrodes Y1 to Yn.

As described above, although wall charges accumulated on the scan electrodes and the address electrodes during the reset period are erased as the address period elapses, the voltage difference between the scan pulse and the data pulse increases such that the address discharge easily occurs between the scan electrodes and the address electrodes.

Further, the generation of the erroneous discharge between the scan electrode and the sustain electrode is prevented by reducing the voltage difference between the scan electrode and the sustain electrode.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A method of driving a plasma display apparatus comprising:
applying a scan pulse to a scan electrode during an address period, the scan pulse falling from a scan reference voltage to a first intermediate voltage, being maintained at the first intermediate voltage, and falling from the first intermediate voltage to a scan voltage; and
applying a data pulse corresponding to the scan pulse to an address electrode during the address period.

2. The method of claim 1, wherein the scan pulse rises from the scan voltage to a second intermediate voltage, is maintained at the second intermediate voltage, and rises from the second intermediate voltage to the scan reference voltage.

3. The method of claim 1, wherein a data voltage of the data pulse is applied to the address electrode during the application of the scan voltage of the scan pulse to the scan electrode.

4. The method of claim 2, wherein an absolute value of the first intermediate voltage is substantially equal to an absolute value of the second intermediate voltage.

5. The method of claim 1, wherein a sustain pulse alternately having a positive voltage and a negative voltage is applied to the scan electrode and a ground level voltage is applied to a sustain electrode during a sustain period which follows the address period.

6. The method of claim 1, wherein a sustain pulse alternately having a positive voltage and a negative voltage is applied to a sustain electrode and a ground level voltage is applied to the scan electrode during a sustain period which follows the address period.

7. A method of driving a plasma display apparatus comprising:
applying a first scan pulse to a scan electrode during an address period; and
applying a second scan pulse later than the first scan pulse to the scan electrode during the address period, wherein an absolute value of a first scan voltage of the first scan pulse is less than an absolute value of a second scan voltage of the second scan pulse.

8. The method of claim 7, wherein a sustain pulse alternately having a positive voltage and a negative voltage is applied to the scan electrode and a ground level voltage is applied to a sustain electrode during a sustain period which follows the address period.

9. The method of claim 8, wherein an absolute value of the negative voltage of the sustain pulse is more than an absolute value of a scan reference voltage of the second scan pulse, and is less than an absolute value of the second scan voltage of the second scan pulse.

10. The method of claim 7, wherein a sustain pulse alternately having a positive voltage and a negative voltage is applied to a sustain electrode and a ground level voltage is applied to the scan electrode during a sustain period which follows the address period.

11. The method of claim 10, wherein an absolute value of the negative voltage of the sustain pulse is more than an absolute value of a scan reference voltage of the second scan pulse, and is less than an absolute value of the second scan voltage of the second scan pulse.

12. The method of claim 7, wherein the second scan pulse falls from a scan reference voltage to a first intermediate voltage, is maintained at the first intermediate voltage, and falls from the first intermediate voltage to the second scan voltage.

13. The method of claim 12, wherein the second scan pulse rises from the second scan voltage to a second intermediate voltage, is maintained at the second intermediate voltage, and rises from the second intermediate voltage to the scan reference voltage.

14. The method of claim 12, wherein a data voltage of a data pulse corresponding to the second scan pulse is applied to the address electrode during the application of the second scan voltage of the second scan pulse to the scan electrode.

15. The method of claim 13, wherein an absolute value of the first intermediate voltage is substantially equal to an absolute value of the second intermediate voltage.

16. The method of claim 12, wherein the first scan pulse falls from the scan reference voltage to a third intermediate voltage, is maintained at the third intermediate voltage, and falls from the third intermediate voltage to the first scan voltage.

17. The method of claim 16, wherein the first scan pulse rises from the first scan voltage to a fourth intermediate voltage, is maintained at the fourth intermediate voltage, and rises from the fourth intermediate voltage to the scan reference voltage.

18. The method of claim 16, wherein a data voltage of a data pulse corresponding to the first scan pulse is applied to the address electrode during the application of the first scan voltage of the first scan pulse to the scan electrode.

19. The method of claim 17, wherein an absolute value of the third intermediate voltage is substantially equal to an absolute value of the fourth intermediate voltage.
